(19) United States
(12) Patent Application Publication
(10) Pub. No.: US 2008/0288231 A1
(43) Pub. Date: Nov. 20, 2008

(54) Apparatus and method for cooperation verification

(75) Inventor: Isamu Nakayama, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/149,993

(22) Filed: May 12, 2008

(30) Foreign Application Priority Data
May 14, 2007 (JP) 2007-127784

(51) Int. Cl. G06F 9/455

(52) U.S. Cl. 703/15

(57) ABSTRACT

A cooperation verifying apparatus includes a storage unit and a processing unit. The processing unit simulates a software-based portion and a hardware-based portion in a target system, issues instruction signals from the software-based portion to the hardware-based portion in order during the simulation, stores a data of a progress state of the simulation of the software-based portion in the storage unit, stores the instruction signals in an order of reception as an input history in the storage unit and associates the input history with the progress state data.

### BACKGROUND OF THE INVENTION

1. Field of the Invention

The present invention relates to a cooperation verifying apparatus, and a cooperation verifying method, in which cooperation verification of software and hardware is performed in circuit design. This patent application is based on Japanese Patent Application No. JP 2007-127784. The disclosure thereof is incorporated herein by reference.

2. Description of Related Art

In recent years, a SOC (System on Chip) in which multiple functions of a processor, a memory, peripheral circuits and so on are integrated on one chip has been widely used. The SOC (for example, a system LSI) is formed of a software-based portion and a hardware-based portion, and the software-based portion and the hardware-based portion operate in cooperation. In designing such an SOC, conventionally, the software-based portion and hardware-based portion are independently developed and after completion of the hardware-based portion, they are unified, and then, the operation is verified. According to this method, the software-based portion cannot be verified until the design of the hardware-based portion is ended. Furthermore, when a trouble is found in the verification, it is difficult to specify a cause of the trouble. Especially, when such a trouble that requires re-design of the hardware-based portion is found, development costs and development period significantly increase.

For this reason, nowadays, hardware/software cooperation verification (hereinafter, to be referred to as cooperation verification) for verifying the operation of the system in cooperation of the hardware-based portion and the software-based portion before completion of the hardware-based portion is widely utilized. In the cooperation verification, a hardware model generated based on RTL (Register Transfer Level) description using system description language (for example, Verilog-XL) is operated in cooperation with a software model as a program described in C language, and the operation of the entire system is simulated to verify whether or not mismatch between them exists. Thus, the design can be performed without dividing the system and the operation of the system can be verified while using these models.

When a system as a target of cooperation verification becomes larger or complicated, a simulation time and a booting time of OS (Operating System) in the simulation increase in the cooperation verification. In the verification system for only a software-based portion, for example, as described in Japanese Patent Application Publication (JP-A-Heisei 8-185341), a progress state of simulation can be recovered by storing/re-executing internal statuses on the side of a software-based portion (state in a register or memory). For this reason, in the verification system for only the software-based portion, it is possible to omit an already verified portion of the simulation and restart the simulation from a portion to be debugged, and thereby the verification can be made efficient.

On the contrary, when a hardware-based portion is incorporated into the simulation environment as in the cooperation verification, a new circuit for acquiring statuses of all registers in the hardware-based portion and states of signals need to be incorporated into the hardware-based portion, in order to save a progress state of the hardware-based portion. Addition of the function of saving the progress state to the entire hardware-based portion requires a substantial change of the circuit, which is difficult to implement. For this reason, in the cooperation verification using a logical emulator and a hardware accelerator, it is difficult to store/re-execute the progress state of simulation. When the simulation is interrupted or a trouble occurs, the simulation needs to be started from the beginning. For example, when a trouble point is debugged, verification efficiency is lowered, since a long time is spent for the start of OS with no relation to debugging and an already verified portion of the simulation in the period from the start of simulation to the trouble point. Generally, according to the cooperation verifying method, debugging needs to be repeated for each of many trouble points. Thus, as described above, when the progress state of simulation cannot be stored/re-executed, the verification time greatly increases.

In this way, there is a strong demand for reducing the verification time of cooperation verification. Especially, a cooperation verifying method is demanded that can reduce the booting time of the OS with no relation to debugging and the simulation time of an already verified portion, thereby achieving an efficient debugging process.

### SUMMARY

In an first aspect of the present invention, a cooperation verifying apparatus includes a storage unit; and a processing unit configured to simulate a software-based portion and a hardware-based portion in a target system, to issue instruction signals from the software-based portion to the hardware-based portion in order during the simulation, to store a data of a progress state of the simulation of the software-based portion in the storage unit, to store the instruction signals in an order of reception as an input history in the storage unit and to associate the input history with the progress state data.

In another aspect of the present invention, a method of cooperation verification, includes simulating a software-based portion and a hardware-based portion in a target system; issuing instruction signals from the software-based portion to the hardware-based portion in order during the simulation; storing a data of a progress state of the simulation of the software-based portion in a storage unit; storing the instruction signals in an order of reception as an input history in the storage unit; and associating the input history with the progress state data.

In still another aspect of the present invention, a computer-readable software product comprising codes, executed by a computer, for a method of cooperation verification is provided. The method comprises simulating a software-based portion and a hardware-based portion in a target system; issuing instruction signals from the software-based portion to the hardware-based portion in order during the simulation; storing a data of a progress state of the simulation of the software-based portion in a storage unit; storing the instruction signals in an order of reception as an input history in the storage unit; and associating the input history with the progress state data.

A cooperation verifying apparatus, and a cooperation verifying method according to the present invention can reduce time for cooperation verifying.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a diagram showing the configuration of a cooperation verifying apparatus according to the present invention;

FIG. 2 is a block diagram showing the configuration of the cooperation verifying apparatus according to an embodiment of the present invention;

FIG. 3 is a block diagram showing the configuration of a target LSI in the cooperation verification in the embodiment of the present invention;

FIG. 4 is a diagram showing an example of an address map on an input side of an I/O circuit in the embodiment of the present invention;

FIG. 5 is a diagram showing an example of an address map on an output side of the I/O circuit in the embodiment of the present invention;

FIG. 6 is a diagram showing an example of input history in the cooperation verifying apparatus according to the embodiment of the present invention; and

FIG. 7 is a flow chart of a recording operation of the input history in the cooperation verifying apparatus according to the embodiment of the present invention.

### DESCRIPTION OF THE PREFERRED EMBODIMENTS

Hereinafter, a cooperation verifying apparatus according to the present invention will be described in detail with reference to the attached drawings.

In the present invention, the cooperation verifying apparatus verifies cooperation of a program-based portion (a software model) of a system LSI described in C language and a hardware-based portion (a hardware model) thereof formed in the form of an FPGA (Field Programmable Gate Array) based on a RTL (Register Transfer Level) description.

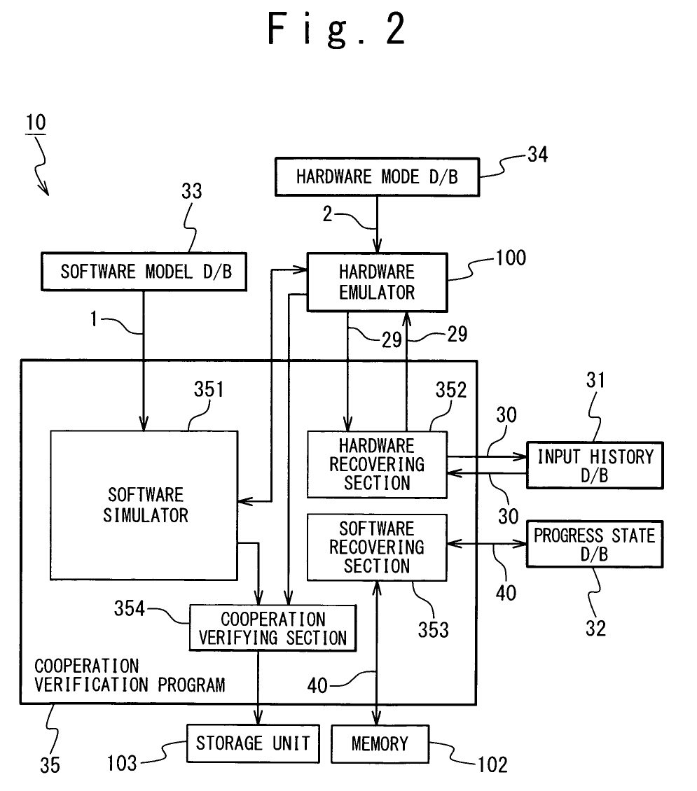

Referring to FIG. 2, according to the present invention, the cooperation verifying apparatus 10 records an instruction signal issued from the software-based portion to the hardware-based portion as a part of an input history 30 in a simulation that the software-based portion and the hardware-based portion cooperate with each other. The cooperation verifying apparatus 10 records an internal state of the software-based portion at an optional time (for example, statuses of registers in a target CPU of the system LSI and a state of a memory of the system LSI) as progress state data 40. When restarting the cooperation verification at an optional time, the cooperation verifying apparatus 10 recovers the internal state of the software-based portion (the CPU, the memory or the like) at the optional time on the basis of the progress state data 40 at the optional time. Also, the cooperation verifying apparatus 10 recovers a state of the hardware-based portion on the basis of the input history 30 recorded from the start of cooperation verification at an optional time. At this time, the CPU of the system LSI sends the instruction signals recorded in the input history 30 to the hardware-based portion in older order in history and recovers the state of the hardware-based portion. Thus, the time of simulation from the start of the simulation to a portion to be debugged can be reduced. The cooperation verifying apparatus according to the present invention will be described below in more detail.

### (Configuration of Cooperation Verifying Apparatus)

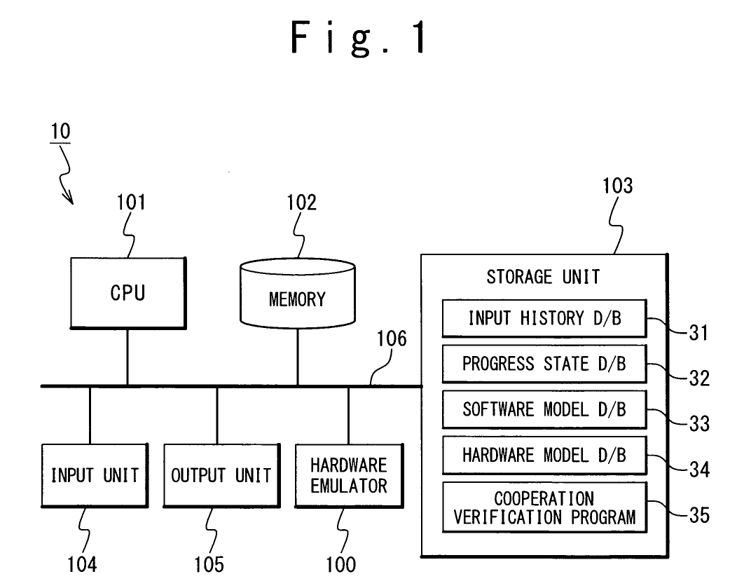

Referring to FIGS. 1 to 5, the configuration of the cooperation verifying apparatus 10 according to an embodiment of the present invention will be described. FIG. 1 is a block diagram showing the configuration of the cooperation verifying apparatus 10. Referring to FIG. 1, the cooperation verifying apparatus 10 in the embodiment includes a hardware emulator 100, a CPU 101, a memory 102, a storage unit 103, an input unit 104 and an output unit 105, which are interconnected via a bus 106. The storage unit 103 is such as a hard disc and a memory. The input unit 104 is such as a keyboard and a mouse and outputs various data to the CPU 101 and the storage unit 103 by a user (designer). The output unit 105 is such as a monitor or a printer, and visibly provides a cooperation verification result outputted from the CPU 101 to the user.

The storage unit 103 is such as a hard disc, a memory and an optical storage medium, and stores an input history database (D/B) 31, a progress state database (D/B) 32, a software model database (D/B) 33, a hardware model database (D/B) 34 and a cooperation verification program 35 therein. The software model D/B33 and the hardware model D/B34 stores a target program 1 and an RTL description 2 (to be described later), respectively. The cooperation verification program 35 is used for a circuit simulator for performing a simulation for cooperation verification of the system LSI by using the software-based portion (software model) and the hardware-based portion (hardware model).

In response to a command from the input unit 104, the CPU 101 executes the cooperation verification program 35 stored in the storage unit 103 for a cooperation verifying process. At this time, various kinds of data and programs read out from the storage unit 103 are temporarily stored in the memory 102 (for example, RAM), and the CPU 101 executes various kinds of processes by using the data stored in the memory 102.

Referring to FIG. 2, a test circumstance for cooperation verification is provided when the cooperation verification program 35 is executed by the CPU 101. The test circumstance includes functions of a software simulator 351, a hardware recovering section 352, a software recovering section 353 and a cooperation verifying section 354. The software simulator 351 executes the target program 1 described in the C language to perform simulation of the software-based portion. Thereby, the software simulator 351 functions as the software-based portion to be verified.

The hardware recovering section 352 monitors a hardware emulator 100 and records instruction signals 29 issued from the software-based portion to the hardware-based portion in the input history database 31 as a part of the input history 30 in a reception order. When the simulation is restarted, the hardware recovering section 352 reads out the input history from the input history database 31 and outputs the instruction signals 29 to the hardware-based portion in the older order of the history based on the input history 30 read out from the input history database 31. Thus, the hardware recovering section 352 recovers the progress state of the hardware-based portion.

The software recovering section 353 records the simulation state (internal state) of the target program 1 at an optional time or at an optional program portion in the progress state database (D/B) 32 as the progress state data 40. At this time, the software recovering section 353 acquires data stored in the memory 102 and held by registers (not shown) at the optional time or at the optional program portion of the target program 1 and records the acquired data as the progress state data 40. When the simulation is restarted, the software recovering section 353 reads out the progress state data 40 stored in the progress state database 32 and rewrites the memory 102 and the registers in accordance with the progress state data 40. Thus, the software recovering section 353 recovers the state of the memory 102 and the registers on the simulation.

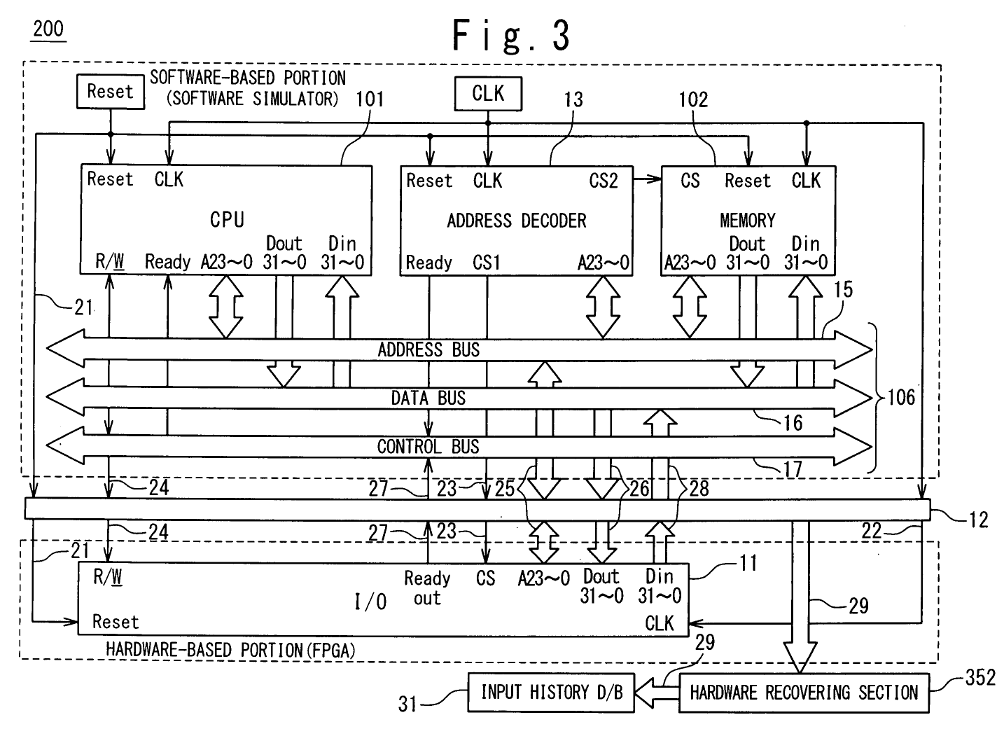

The hardware emulator 100 is a logical emulator which realizes the hardware model on the basis of the RTL description 2 recorded in the hardware model database (D/B) 34. Referring to FIG. 3, the hardware emulator 100 has an FPGA which forms the hardware-based portion (hardware model) based on the RTL description 2. Since the FPGA can constitute the hardware-based portion based on the program, it is preferable to use as the model to be debugged. The FPGA in the present embodiment constitutes an I/O circuit 11 (FIG. 3) as an example. The I/O circuit 11 is connected to a bus 106 via a terminal block 12 and sends/receives a signal and data to/from the CPU 201 of the system LSI and the memory 202 thereof. Here, it is assumed that the I/O circuit 11 can process (add and invert) data supplied from the CPU 201.

The cooperation verifying section 354 acquires simulation results from the software simulator 351 and the hardware emulator 100 and verifies validity of design of the software model and the hardware model based on the simulation results. The cooperation verifying section 354 also outputs a verification result to the storage unit 103 and output unit 105.

By the above-mentioned configuration, the cooperation verifying apparatus 10 performs cooperation verification of the system LSI as shown in FIG. 3 (hereinafter, to be referred to as a target LSI 200). Referring to FIG. 3, the target LSI 200 has the CPU 201, the memory 202, and an address decoder 13, which function as the software model, and the I/O circuit 11 (FPGA) which functions as the hardware model. The I/O circuit 11, the CPU 201 and the memory 202 are interconnected via the bus 106. The bus 106 has an address bus 15, a data bus 16 and a control bus 17. The I/O circuit 11 is connected to the bus 106 via the terminal block 12.

The hardware recovering section 352 monitors instruction signals 29 as signals which pass through the terminal block 12 between the I/O circuit 11 and the bus 106, and acquires data and signals sent from the CPU 201 to the I/O circuit 11 as the instruction signals 29. The following instruction signals from the software-based portion are received by the I/O circuit 11. That is, the instruction signals are such as a reset signal 21 (Reset) for instructing initialization, a system clock 22 (CLK), a chip select signal 23 (CS) for instructing a destination of data, a read/write signal 24 (R/W) for instructing read/write of data, an address signal 25 (A23 to A0), and data 26 (Dout31 to Dout0). The following signals are outputted from the I/O circuit 11 to the software-based portion. That is, the signals are such as a ready signal 27 (Readyout), the address signal 25, and a data 28 (Din31 to Din0). However, it would be needless to say that the signals and data inputted/outputted to/from the I/O circuit 11 are not limited to them.

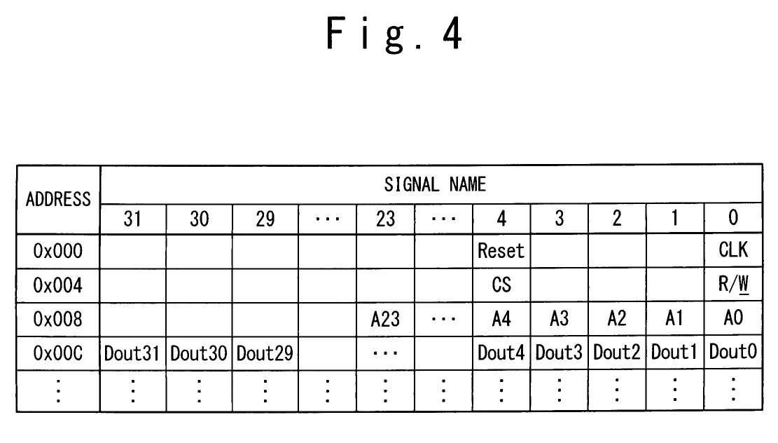

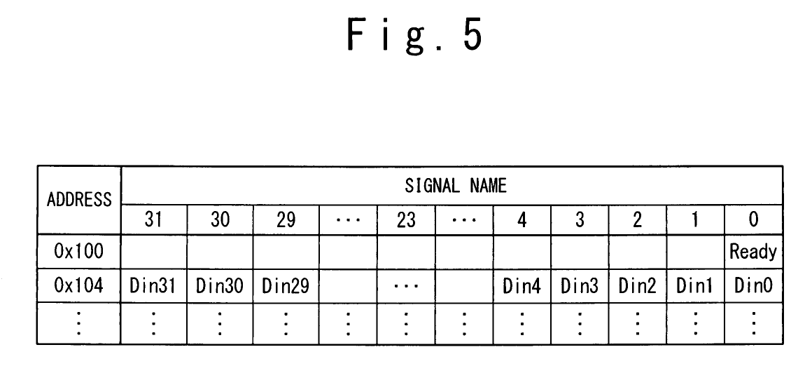

The I/O circuit 11 has an address map as shown in FIGS. 4 and 5. Referring to FIG. 4, the instruction signal supplied to the I/O circuit 11 is associated with an address of signal lines (terminal) for each signal type. For example, in a bus for the address of “0x000”, a system clock signal (CLK) 22 is associated with a signal line (terminal) corresponding to the 0^{th} bit, and a reset signal (Reset) 21 is associated with a signal line corresponding to the fourth bit. In the bus for the address of “0x004”, the read/write (R/W) signal 24 is associated with the signal line (terminal) corresponding to the 0^{th} bit of and a chip select signal (CS) 23 is associated with the signal line corresponding to the fourth bit. In the bus for the address of “0x008”, the address signals 25 (A0 to A23) are associated with the respective signal lines (terminals) corresponding to the 0^{th} to 23^{rd} bits. In the bus for the address of “0x00C, the data 26 (Dout0 to Dout31) are associated with the respective signal lines (terminals) corresponding to the 0^{th} to 31^{st} bits. Referring to FIG. 5, the instruction signals outputted from the I/O circuit 11 are associated with an address of the signal line (terminal) for each signal type. For example, in the bus for the address of “0x100”, the ready signal (Readyout) 27 is associated with the signal line (terminal) corresponding to the 0^{th} bit. In the bus for the address of “0x008”, data (Din0 to Din31) 26 are associated with the respective signal lines (terminals) corresponding to the 0^{th} to 31^{st} bits.

Next, a recording operation of the input history in the cooperation verification according to the present invention will be described in detail.

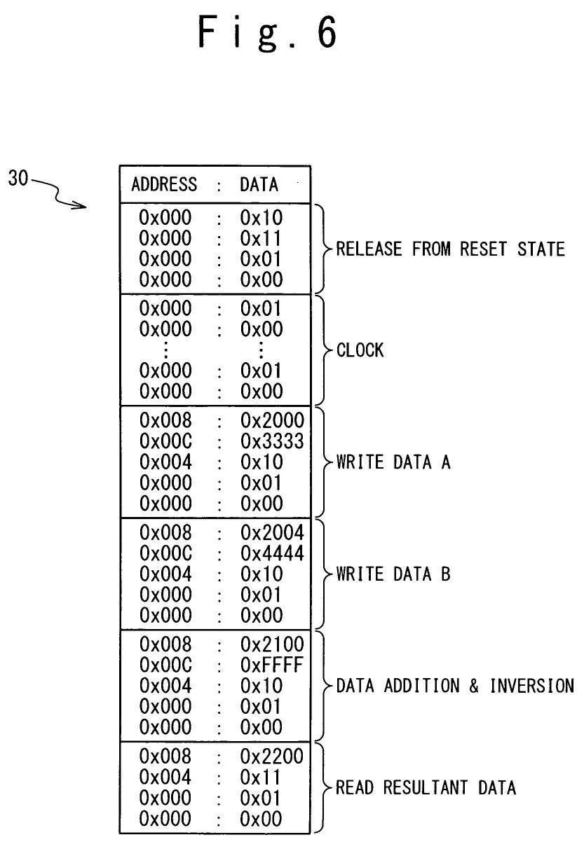

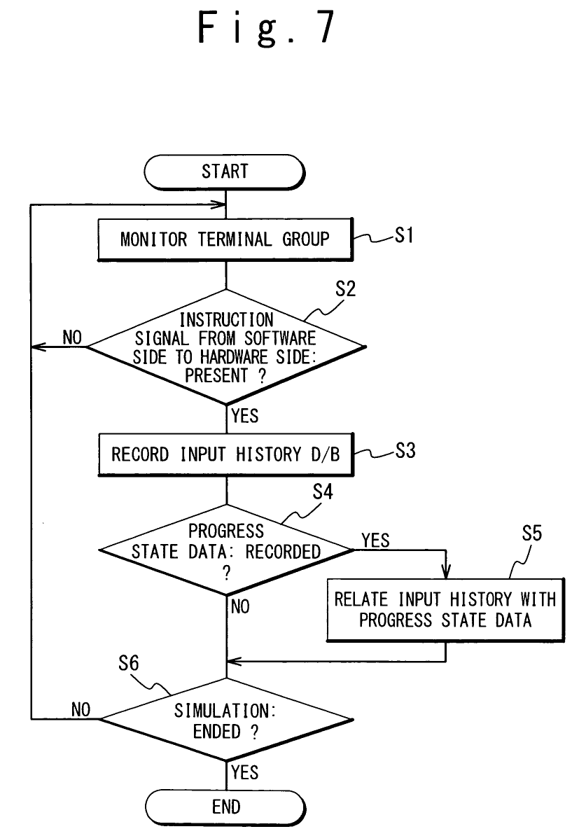

In the cooperation verification, the cooperation verifying apparatus 10 according to the embodiment of the present invention stores signals supplied from the software-based portion to the hardware-based portion as the input history. Referring to FIGS. 6 and 7, the recording operation of the input history in the cooperation verification will be described. Referring to FIG. 7, when the cooperation verifying apparatus 10 starts verification of the target LSI 200, the hardware recovering section 352 starts monitoring of the terminal block 12 (Step S1). Here, the hardware recovering section 352 monitors the instruction signals 29 outputted from the software simulator 351 through the hardware emulator 100, as signals to transferred from the software-based portion to the I/O circuit 11 through the terminal block 12, that is, on the buses corresponding to the addresses of “0x000”, “0x004”, “0x008”, “0x00C”, . . . shown in FIG. 4. When the instruction signal 29 is sent from the software-based portion to the hardware-based portion (I/O circuit 11) (YES at Step S2), the hardware recovering section 352 associates the instruction signal 29 with an address of the terminal to which the signal is supplied and records the signal in the input history database 31 (Step S3).

Also, the software recovering section 353 records the simulation result of the software-based portion from the start of cooperation verification at an optional time in the progress state database 32 as the progress state data 40. When the progress state data 40 is recorded (Yes at Step S4), the hardware recovering section 352 associates the progress state data 40 with the input history 30 having recorded in the input history database 31 until the time when the progress state data 40 is recorded (Step S5). When the progress state data 40 is not recorded (No at Step S4) or the simulation (cooperation verification) continues after the process at the Step S5, the hardware recovering section 352 continues to monitor the instruction signal 29 to be appeared on the terminal block 12 (recording of the input history 30) (No at Step S6). When the simulation (cooperation verifying) is ended, the hardware recovering section 352 ends monitoring of the instruction signals 29 (recording of the input history 30) (Yes at Step S6). That is, regardless of whether the progress state data 40 is recorded or not, the hardware recovering section 352 repeats recording of the instruction signal 29 (recording of the input history 30) until the simulation (cooperation verifying) is ended.

As described above, during a period between the start and end of the cooperation verification, the hardware recovering section 352 records the instruction signals 29 sent from the software-based portion to the hardware-based portion as a part of the input history 30. The hardware recovering section 352 can also associate the progress state data 40 with the input history 30 having recorded until the time when the simulation result (progress state data 40) of the software side is recorded.

FIG. 6 is a diagram showing an example of the input history 30 having recorded by the hardware recovering section 352. Here, in the cooperation verification, a case where the software simulator 351 executes the target program 1 for the following process will be described as an example. That is, the software simulator 351 (1) reads two data stored in the memory 202, (2) writes the two data into the I/O circuit 11, (3) issues an instruction to execute a process (here, add the two data and invert the data) to the I/O circuit 11, (4) reads the processed data from the I/O circuit 11, and (5) stores the resultant data in the memory 102 as the memory 202.

The hardware recovering section 352 sequentially extracts the instruction signal 29 from the signal line whose signal level changes, associates the signal with the address of the signal lines and records the signal as the input history 30. It should be noted that the CPU 201 realized by the software simulator 351 initializes the I/O circuit 11. The hardware recovering section 352 sequentially and repeatedly associates received instruction signals 29 of “0x10” and “0x11” with the address of “0x000” and records them. Subsequently, the CPU 101 releases a reset state. At this time, the reset signal 21 supplied from the CPU 101 to the I/O circuit 11 changes from the high level “1” to the low level “0”. The hardware recovering section 352 extracts the instruction signal 29 of “0x01”, associates the signal with the address of “0x000” and records it. Subsequently, in accordance with a change in the signal level of the clock signal CLK 22, the hardware recovering section 352 extracts the instruction signal 29 of “0x00” or “0x01”, associates the signal with the address of “0x000” and records it.

Next, the CPU 101 reads data A of “0x3333” stored in the memory 102 and writes the data into a work register of “0x2000” of the I/O circuit 11. At this time, the address signal 25 of “0x2000”, the data 26 of “0x3333”, the chip select signal CS 23 and the write signal 24 are supplied to the I/O circuit 11 as the instruction signals 29 in this order. In this order into the I/O circuit 11, the hardware recovering section 352 associates the instruction signal 29 of “0x2000” with the address of “0x008” and records it, associates the instruction signal 29 of “0x3333” with the address of “0x00C” and records it and associates the instruction signal 29 of “0x10” with the address of “0x004” and records it. When writing the data A into the work register of “0x2000”, the I/O circuit 11 sends the ready signal 27 to the CPU 101.

The CPU 101 receives the ready signal 27 and reads data B of “0x4444” stored in the memory 102 and writes the data into the work register of “0x2004” of the I/O circuit 11. At this time, the address signal 25 of “0x2004”, the data 26 of “0x4444”, the chip select signal CS 23 and the write signal 24 are supplied to the I/O circuit 11 as the instruction signals 29 in this order. In this order of signals to the I/O circuit 11, the hardware recovering section 352 associates the instruction signal 29 of “0x2004” with the address of “0x008” and records it, associates the instruction signal 29 of “0x4444” with the address of “0x00C” and records it and associates the instruction signal 29 of “0x10” with the address of “0x004” and records it. When writing the data B into the work register of “0x2004”, the I/O circuit 11 sends the ready signal 27 to the CPU 101.

The CPU 101 receives the ready signal 27 and writes the instruction signal 29 of “0xFFFF” for adding the data A and data B and inverting, into a control register of “0x2100” in the I/O circuit 11. At this time, the address signal 25 of “0x2100”, the data 26 of “0xFFFF”, the chip select signal CS 23 and the write signal 24 are supplied to the I/O circuit 11 as the instruction signals 20 in this order. In this order of reception by the I/O circuit 11, the hardware recovering section 352 associates the instruction signal 29 of “0x2100” with the address of “0x008” and records it, associates the instruction signal 29 of “0xFFFF” with the address of “0x00C” and records it and associates the instruction signal 29 of “0x10 with the address of “0x004” and records it.

Based on the instruction data of “0xFFFF” in the control register, the I/O circuit 11 adds the data A of “0x3333” and data B of “0x4444” and inverts the addition result, and stores the resultant data of “0x8888” in a result register of “0x2200”. When the operation is ended and the resultant data is stored, the I/O circuit 11 sends the ready signal 27 to the CPU 101. The CPU 101 receives the ready signal 27 and reads the resultant data of “0x8888” from the result register of “0x2200” in the I/O circuit 11 and stores the read data in the memory 102. At this time, the address signal 25 of “0x2200”, the data 26 of “0x11”, the chip select signal CS 23 and the read signal 24 are supplied to the I/O circuit 11 as the instruction signals 29 from the CPU 101 in this order. In the order of reception by the I/O circuit 11, as the input history 30, the hardware recovering section 352 associates the instruction signal 2 of “0x2200” with the address of “0x008” and records it, associates the instruction signal 29 of “0x11” with the address of “0x004” and records it. The data 28 of “0x8888” is sent from the I/O circuit 11 to the result register to the CPU 101.

The above-mentioned recording of the input history 30 is performed from the start of cooperation verification to the end or interruption of cooperation verification.

Meanwhile, the software recovering section 353 stores a simulation result at a time A (optional time or optional program portion of the target program) as the progress state data 40. For example, the software recovering section 353 records in the progress state database 32, the progress state data 40 at a time before the program portion that a trouble occurs in cooperation verification (program portion to be debugged) and at the time when the OS in simulation is ended. At this time, the hardware recovering section 352 associates the input history 30 having recorded until the time A with the progress state data 40 at the time A (Step S5). For example, in an event that the progress state data 40 is recorded at a time when the data obtained by adding the data A and data B and inverting the addition result is stored in the memory 102, the hardware recovering section 352 associates the progress state data 40 with the input history 30 shown in FIG. 6.

As described above, according to the present invention, it is possible to associate the simulation result (progress state data 40) of the software-based portion at an optional time with the history (input history 30) of the instruction signal 29 to the hardware-based portion and record it.

Next, a method of re-executing simulation in the cooperation verifying apparatus 10 of the present invention on the way (time A) will be described. When re-executing simulation from the time A, the cooperation verifying apparatus 10 recovers internal state of the software-based portion at the time A by the software recovering section 353 and also recovers the internal statuses of the hardware-based portion at the time A by the hardware recovering section 352.

The software recovering section 353 recovers the states of the memory 102 and registers in the CPU 101 by using the progress state data 40 having recorded at the time A. The hardware recovering section 352 refers to the input history 30 having recorded from the start of cooperation verification to the time A and sends the instruction signals 29 to the I/O circuit 11 in order of the history (in the order of the signals received by the I/O circuit 11). For example, when the input history 30 as shown in FIG. 6 is recorded until the time A, the hardware recovering section 352 sends the instruction signals 29 from reset relief to read of the resultant data to the I/O circuit 11. Thereby, the I/O circuit 11 can re-execute the process instructed by the CPU 101 until the time A and recovers the result of simulation at the time A. According to the present invention, since transmission of the signal and data (for example, ready signal 27 and data 28) from the hardware-based portion (I/O circuit 11) to the software-based portion is omitted, the time necessary for recovery of the progress state of the hardware is greatly reduced.

As described above, according to the present invention, since the state of the hardware-based portion in cooperation verification is recovered by using the instruction signals sent from the software-based portion to the hardware-based portion, the simulation time until the progress state can be reduced. Thus, the simulation time until the debug point and booting time of the OS in simulation can be reduced, thereby achieving efficient cooperation verification.

Although the present invention has been described above in connection with several embodiments thereof, it would be apparent to those skilled in the art that those embodiments are provided solely for illustrating the present invention, and should not be relied upon to construe the appended claims in a limiting sense. Any modification which does not deviate from the scope of the present invention is included in the present invention. Although the hardware recovering section 352 in the embodiment is realized by a program executed by the CPU 101, the hardware recovering section 352 is not limited to the program and may be realized by another device which monitors the terminal block 12. Furthermore, the timing of acquiring the instruction signal 29 by the hardware recovering section 352 may be timing based on the system clock 22 or another sampling clock (not shown). When the instruction signal 29 is acquired according to the other sampling clock, the system clock 22 does not need to be recorded as the input history 30. In addition, the target program 1 is not limited to the program written in the C language. The hardware description written into the hardware emulator 100 used as the hardware model is not limited to RTL description.

What is claimed is:

1. A cooperation verifying apparatus comprising:
a storage unit; and
a processing unit configured to simulate a software-based portion and a hardware-based portion in a target system, to issue instruction signals from the software-based portion to the hardware-based portion in order during the simulation, to store a data of a progress state of the simulation of the software-based portion in the storage unit, to store the instruction signals in an order of reception as an input history in the storage unit and to associate the input history with the progress state data.

2. The cooperation verifying apparatus according to claim 1, wherein said processing unit comprises:
a software simulator configured to simulate the software-based portion of the target system to issue the instruction signals in order;
a hardware emulator configured to emulate the hardware-based portion of the target system based on the instruction signals;
a software processing section configured to store the progress state data in the storage unit; and
a hardware processing section configured to store the input history in the storage unit and to associate the input history with the progress state data.

3. The cooperation verifying apparatus according to claim 2, wherein said software processing section stores a state of a memory of the target system and statuses of registers of a CPU of the target system in the storage unit as the progress state data.

4. The cooperation verifying apparatus according to claim 2, wherein said hardware processing section stores sets of a command/data and an address for the instruction signals in the storage unit as the input history.

5. The cooperation verifying apparatus according to claim 2, wherein said software processing section reads the progress state data from the storage unit to set into said software simulator, when the simulation is restarted.

6. The cooperation verifying apparatus according to claim 2, wherein said hardware processing section reads the input history from the storage unit to set into said hardware emulator.

7. The cooperation verifying apparatus according to claim 1, wherein said processing unit stores in the storage unit, sets of the instruction signal supplied to the hardware-based portion and an address of a terminal related to the instruction signals.

8. The cooperation verifying apparatus according to claim 1, wherein said processing unit stores the simulation result of the software-based portion at an optional time in the storage unit as a progress state data.

9. The cooperation verifying apparatus according to claim 8, wherein when the simulation is restarted from a predetermined time, said processing unit recovers the simulation result of the software-based portion at the predetermined time, and sends the instruction signals having supplied from the software-based portion to the hardware-based portion during a period from the restart to the predetermined time, to the hardware-based portion.

10. A method of cooperation verification, comprising:
simulating a software-based portion and a hardware-based portion in a target system;
issuing instruction signals from the software-based portion to the hardware-based portion in order during the simulation;
storing a data of a progress state of the simulation of the software-based portion in a storage unit;
storing the instruction signals in an order of reception as an input history in the storage unit; and
associating the input history with the progress state data.

11. The method of cooperation verification according to claim 10, wherein said storing a data of a progress state comprises:
storing the progress state data in the storage unit from a start of the simulation to a predetermined time.

12. The method of cooperation verification according to claim 11, further comprising:
recovering the software-based portion at the predetermined time by setting the progress state data in the software-based portion, when the simulation is restarted from the predetermined time.

13. The method of cooperation verification according to claim 12, further comprising:
recovering the hardware-based portion at the predetermined time by setting the input history in the hardware-based portion, when the simulation is restarted from the predetermined time.

14. A computer-readable software product comprising codes, executed by a computer, for a method of cooperation verification, wherein said method comprises:
simulating a software-based portion and a hardware-based portion in a target system;
issuing instruction signals from the software-based portion to the hardware-based portion in order during the simulation;
storing a data of a progress state of the simulation of the software-based portion in a storage unit;
storing the instruction signals in an order of reception as an input history in the storage unit; and
associating the input history with the progress state data.

15. The computer-readable software product according to claim 14, wherein said storing a data of a progress state comprises:
storing the progress state data in the storage unit from a start of the simulation to a predetermined time.

16. The computer-readable software product according to claim 15, wherein said method further comprises:
recovering the software-based portion at the predetermined time by setting the progress state data in the software-based portion, when the simulation is restarted from the predetermined time.

17. The computer-readable software product according to claim 16, wherein said method further comprises:
recovering the hardware-based portion at the predetermined time by setting the input history in the hardware-based portion, when the simulation is restarted from the predetermined time.
